(19) United States
(12) Patent Application Publication
(10) Pub. No.: US 2026/0122536 A1
(43) Pub. Date: Apr. 30, 2026

(54) DYNAMIC ASSIGNMENT OF RADIO UNITS (RUS) TO DISTRIBUTED UNITS (DUS) AND DUS TO CENTRALIZED UNITS (CUS) USING ASSIGNMENT MANAGER

(71) Applicant: DISH Wireless L.L.C., Englewood, CO (US)

(72) Inventors: Premchand Chandran, Brambleton, VA (US); Farhad Bassirat, Arlington, VA (US); Julio Armenta, Aldie, VA (US); Gurpreet Sohi, Parker, CO (US)

(21) Appl. No.: 18/926,020

(22) Filed: Oct. 24, 2024

(51) Int. Cl. H04W 28/086; H04W 28/08

(52) U.S. Cl. CPC H04W 28/086; H04W 28/0958

(57) ABSTRACT

Technologies for dynamic assignment of radio units (RUs), distributed units (DUs), and centralized units (CUs) in a cellular network are described. One method include receiving a plurality of parameters associated with each radio access network (RAN) component of a plurality of RAN components in a RAN of the cellular network, wherein each RAN component of the plurality of RAN components comprises at least one of: Radio Unit (RU), Distributed Unit (DU), or Centralized Unit (CU); determining whether a first parameter of the plurality of parameters satisfies a first threshold criterion of a plurality of threshold criteria, wherein the first parameter is associated with a first RAN component of the plurality of RAN components, and wherein the first RAN component is assigned to connect with a second RAN component of the plurality of RAN components; and responsive to determining that the at least one parameter of the plurality of parameters satisfies the threshold criterion, adjusting the assignment of the first RAN component to the second RAN component to an assignment of the first RAN component to a third RAN component of the plurality of RAN components.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some components in a 5G NR cellular network are preconfigured, and some pre-configurations cannot be dynamically changed, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing dynamic assignment of network elements in a radio access network of a cellular network according to at least one embodiment.

FIG. 2 is a block diagram of a system including assignment managers that implement dynamic assignment of network elements in a radio access network of a cellular network according to at least one embodiment.

FIG. 3 illustrates example assignment managers that implement dynamic assignment of network elements in a radio access network of a cellular network according to at least one embodiment.

FIGS. 4, 5, and 6 are flow diagrams of example methods of that implement dynamic assignment of network elements in a radio access network of a cellular network according to at least one embodiment.

### DETAILED DESCRIPTION

Technologies for dynamic assignment of network elements (e.g., radio units (RUs), distributed units (DUs), and centralized units (CUs)) in a radio access network of a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The assignment of radio units (RUs) to distributed units (DUs) and the assignment of distributed units (DUs) to centralized units (CUs) are determined at the initial stage when the RUs are powered on and cannot be modified. As such, a RU connects to a specific DU throughout the entire period of connection, and a DU connects to a specific CU throughout the entire period of connection.

Aspects and embodiments of the present disclosure address the above and other deficiencies by providing a system that implements dynamic assignment of radio units (RUs), distributed units (DUs), and centralized units (CUs) in a cellular network. Specifically, a component of the cellular network (e.g., assignment manager) may be implemented into the cellular network or one or more of portions (e.g., one or more radio access networks (RANs)) in the cellular network. The component of the cellular network (e.g., assignment manager) may consider parameters associated with each RU, each DU, and each CU in the cellular network (or one or more of portions in the cellular network) to determine the dynamic assignment of RUs, DUs, and CUs such that the resources of the cellular network can be used more efficiently.

Specifically, the component of the cellular network (e.g., assignment manager) may monitor these parameters or receive, upon requesting, the information of these parameters. In one implementation, the parameters associated with a RU, a DU, and a CU may characterize at least one of: a distance between the RU and the DU, the number of RUs connected to the DU, an amount of data demand requested by the RU, a status of the RU, a status of the DU, or a load balancing metric of DUs. In one implementation, the parameters associated with a RU, a DU, and a CU may characterize at least one of: a distance between the DU and the CU, a number of DUs connected to the CU, a status of the DU, a status of the CU, or the load balancing metric of CUs.

In some implementations, the status of RU comprises at least one parameter specifying one or more of: data transaction handled by the RU, an available capacity of the RU, an available bandwidth of the RU, or power consumption of the RU. The available capacity of RU may refer to the available maximum amount of data that a radio transceiver can transmit or receive within a specific time frame. In some implementations, the status of DU comprises at least one parameter specifying one or more of: data transaction handled by DU, an available capacity of the DU, or interference to the DU from other network elements. The available capacity of DU may comprise at least one of: the available capacity of memory allocated to the DU, the available capacity of storage allocated to the DU, the available number of CPU allocated to the DU, or the available bandwidth of network interconnection, provided locally (e.g., physically) or in the cloud (e.g., in virtualization), allocated to the DU. In some implementations, the status of CU comprises at least one parameter specifying one or more of: data transaction handled by the CU, a capacity of the CU, or interference to the CU from other network elements. The available capacity of CU may comprise at least one of: the available capacity of memory allocated to the CU, the available capacity of storage allocated to the CU, the available number of CPU allocated to the CU, or the available bandwidth of network interconnection, provided locally (e.g., physically) or in the cloud (e.g., in virtualization), allocated to the CU.

In some implementations, the load balancing metric of DUs may define a value that represents the load distribution among DUs. For example, the value may be proportional to the difference between the lowest amount of DU load and the highest amount of DU load among these DUs, and in such case, a higher value means the load distribution is relatively unbalanced (which may require adjustment of assignment of DUs), while a lower value means the load distribution is relatively balanced.

In some implementations, the load balancing metric of DUs may define a value that represents the load distribution among CUs. For example, the value may be proportional to the difference between the lowest amount of CU load and the highest amount of CU load among these CUs, and in such case, a higher value means the load distribution is relatively unbalanced (which may require adjustment of assignment of CUs), while a lower value means the load distribution is relatively balanced.

The component of the cellular network (e.g., assignment manager) may determine whether one or more parameters described above satisfy at least one threshold criterion of various threshold criteria to trigger an adjustment of the assignment of the associated RUs, DUs, and CUs. For example, the component of the cellular network (e.g., assignment manager) may compare the parameters with various threshold criteria and determine that when a specific parameter described above reaches or exceeds (or not reach or exceed) a threshold value, the parameter satisfies the threshold criterion. In another example, the component of the cellular network (e.g., assignment manager) may predict a reference value of the parameters based on historical data using a machine learning model and determining that when the reference value reaches or exceeds (or not reach or exceed) a threshold value, the parameter satisfies the threshold criterion.

Responsive to determining that one or more parameters satisfy at least one threshold criterion, the component of the cellular network (e.g., assignment manager) may adjust the assignment of the associated RUs, DUs, and CUs according to one or more predefined adjustment policies, for example, such that the threshold criterion is not satisfied any more. The predefined adjustment policy may be customized.

Aspects and embodiments of the present disclosure can use assignment manager for dynamic assignment of RUs, DUs, and CUs in the cellular network, instead of the static assignment. Aspects and embodiments of the present disclosure can improve the efficiency in resource usage, provide enhanced load management, and allow re-assignment of RUs, DUs, and CUs in the case of failure in one or more network elements.

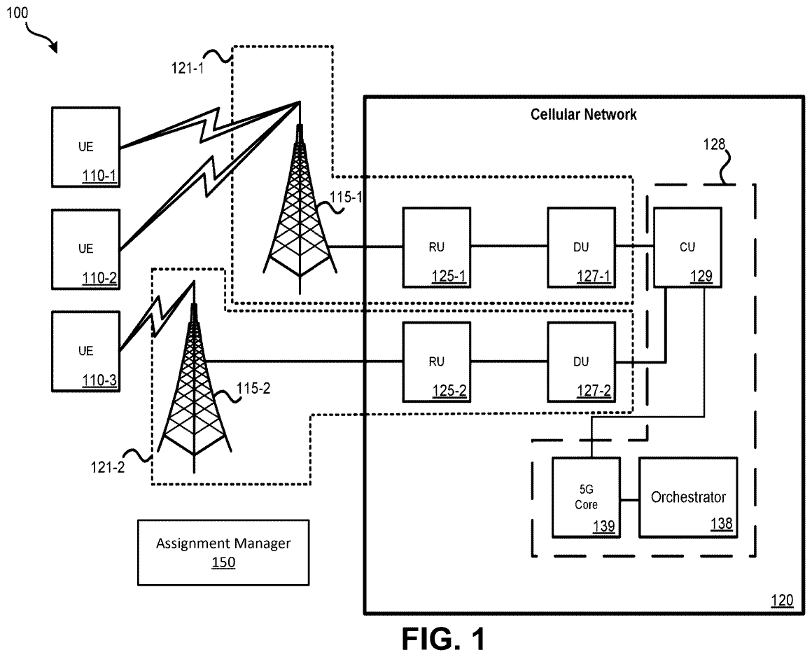

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129.

Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139.

Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

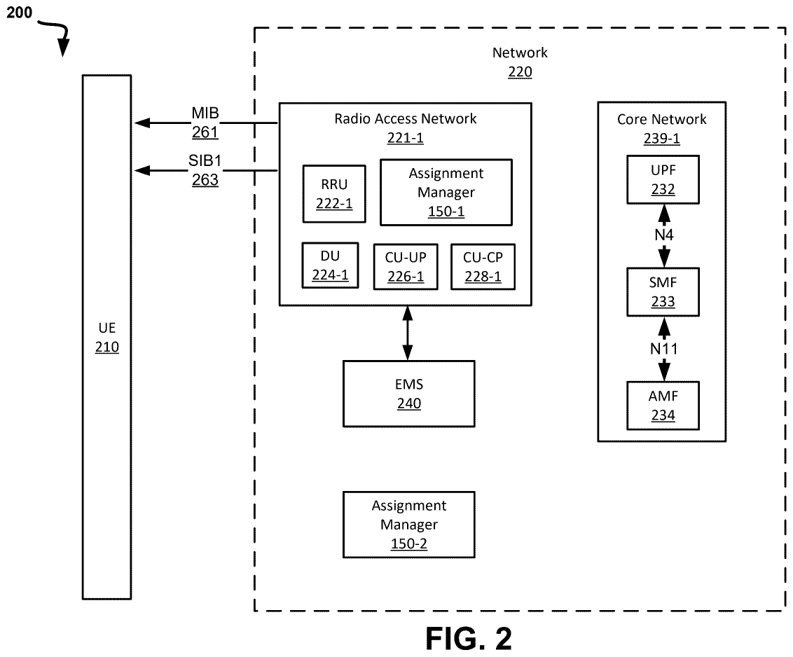

In some embodiments, the system 100 can include an assignment manager 150 to implement dynamic assignment of network elements in a cellular network. Further details regarding the operations of the assignment manager are described below with reference to FIGS. 2-6.

FIG. 2 is a block diagram of example assignment managers according to at least one embodiment. Referring to FIG. 2, a network 220 includes one or more radio access network (RAN) 221-1, and one or more core network 239-1, according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device.

In at least one example, the UE 210 can include a 5G smartphone or a 5G cellular device that connects to the RAN 221-1, via a wireless connection. The UE 210 can include one of a number of UEs not depicted that are in communication with the RAN 221-1. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221-1.

The RAN 221-1 includes a remote radio unit (RRU) 222-1 for wirelessly communicating with UE 210. The remote radio unit (RRU) 222-1 can include a radio unit (RU) and may include one or more radio transceivers for wirelessly communicating with UE 210. The remote radio unit (RRU) 222-1 may include circuitry for converting signals sent to and from an antenna of a Base Station into digital signals for transmission over packet networks. In some implementations, the RAN 221-1 may correspond with a 5G radio Base Station that connects user equipment to the core network 239-1. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The RAN 221-1 can include a new-generation radio access network (NG-RAN) that uses the 5G NR interface. In some embodiments, the distributed unit (DU) 224-1 and the centralized unit (CU) of the RAN 221-1 may be co-located with the RRU 222-1. In other embodiments, the DU 224-1 and the RRU 222-1 may be co-located at a cell site and the centralized unit (CU) may be located within a local data center (LDC). The DU 224-1 can include a logical node configured to provide functions for the radio link control (RLC) layer, the medium access control (MAC) layer, and the physical layer (PHY) layers. The centralized unit (CU) can be partitioned into a CU user plane portion (CU-UP) 226-1 and a CU control plane portion (CU-CP) 228-1. The CU-CP 228-1 may perform functions related to a control plane, such as connection setup, mobility, and security. The CU-UP 226-1 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228-1 can include a logical node configured to provide functions of the control plane part of the RRC and PDCP. The centralized unit for the user plane(CU-UP) 226-1 can include a logical node configured to provide functions of the user plane part of the SDAP and PDCP. In some embodiments, the RAN 221-1 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221-1 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239-1 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239-1 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 334 may interface with the SMF 333 to track user sessions. The AMF 334 may interface with a network slice selection function (NSSF) 338 to select network slice instances for user equipment. When user equipment is leaving a first coverage area and entering a second coverage area, the AMF 334 may be responsible for coordinating the handoff between the coverage areas whether the coverage areas are associated with the same radio access network or different radio access networks. The SMF 333 may perform session management, user plane selection, and Internet Protocol (IP) address allocation. After the Access Gateway Function (AGF) authenticates the subscriber and establishes a protocol data unit (PDU) session, the SMF 333 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the RAN 221-1 and/or transfer uplink data received from the UE 210 to the data network via the RAN 221-1. An uplink can include a radio link though which UE 210 transmits data and/or control signals to the RAN 221-1. A downlink can include a radio link through which the RAN 221-1 transmits data and/or control signals to the UE 210.

Uplink packets arriving from the RAN 221-1 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the RAN 221-1 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221-1. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221-1 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) (not shown) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221-1. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

In some implementations, RAN 221-1 may include the assignment manager 150-1 to implement dynamic assignment of network elements in RAN 221-1. In some implementations, network 220 may include the assignment manager 150-2 to implement dynamic assignment of network elements in network 220 or in part of network 220. For example, the part of network 220 may refer to a portion of network 220 or a region of the network 220. In some implementations, one or more assignment managers may be included in other part(s) of the network 220. In some implementations, each assignment manager described in FIG. 2 may be the same as the assignment manager 150. In some implementations, one or more assignment managers described in FIG. 2 may work together to fulfill the functions provided by the assignment manager 150.

In some implementations, the assignment manager 150-1 may receive information of parameters associated with each RU, each DU, and each CU in RAN 221-1. The parameters associated with a RU, a DU, and a CU in RAN 221-1 may characterize at least one of: a distance between the RU and the DU, the number of RUs connected to the DU, the amount of data demand requested by the RU, the status of RU, the status of DU, or the load balancing between DUs in RAN 221-1. The parameters associated with a RU, a DU, and a CU in RAN 221-1 may characterize at least one of: a distance between the DU and the CU (e.g., latitude and longitude), the number of DUs connected to the CU, the status of DU, the status of CU, or the load balancing between CUs in RAN 221-1. In some implementations, the assignment manager 150-1 may receive information of the hardware information (e.g., serial number and firmware version), the positioning information (e.g., latitude and longitude), etc. of RU, DU, and CU, along with or included in the parameters associated with RU, DU, and CU.

In some implementations, the status of RU comprises at least one parameter specifying one or more of: data transaction handled by RU, an available capacity of RU, an available bandwidth of RU, or power consumption of RU. The available capacity of RU may refer to the available maximum amount of data that a radio transceiver can transmit or receive within a specific time frame.

In some implementations, the status of DU comprises at least one parameter specifying one or more of: data transaction handled by DU, an available capacity of DU, or interference to DU from other network elements. The available capacity of DU may comprise at least one of: the available capacity of memory allocated to the DU, the available capacity of storage allocated to the DU, the available number of CPU allocated to the DU, or the available bandwidth of network interconnection, provided locally (e.g., physically) or in the cloud (e.g., in virtualization), allocated to the DU.

In some implementations, the status of CU comprises at least one parameter specifying one or more of: data transaction handled by CU, a capacity of CU, or interference to CU from other network elements. The available capacity of CU may comprise at least one of: the available capacity of memory allocated to the CU, the available capacity of storage allocated to the CU, the available number of CPU allocated to the CU, or the available bandwidth of network interconnection, provided locally (e.g., physically) or in the cloud (e.g., in virtualization), allocated to the CU.

In some implementations, the assignment manager 150-1 may monitor the parameters associated with each RU, each DU, and each CU in RAN 221-1 that are described above. For example, the assignment manager 150-1 may monitor a distance between the RU and the DU, the number of RUs connected to the DU, the status of RU, the status of DU, the load balancing between DUs in RAN 221-1, a distance between the DU and the CU, the number of DUs connected to the CU, the status of CU, or the load balancing between CUs in RAN 221-1.

In some implementations, the assignment manager 150-1 may compare the received or monitored parameters with various threshold criteria for dynamic assignment to determine whether one or more parameters satisfy at least one threshold criterion. In some implementations, the assignment manager 150-1 may determine that when a specific parameter described above reaches or exceeds a threshold value, the parameters satisfy the threshold criterion. In some implementations, the assignment manager 150-1 may determine that when each of several parameters described above reaches or exceeds a threshold value, the monitored parameters satisfy the threshold criterion.

In one example, a first parameter may be the number of RUs that can be connected to a specific DU (or each DU in RAN 221-1), and a first threshold criterion may define a maximum number of RUs that can be connected a specific DU (or each DU in RAN 221-1). The assignment manager 150-1 may receive or monitor the first parameter, and compare the first parameter with the first threshold criterion. When the value of the first parameter is larger than the maximum number defined in the first threshold criterion, the assignment manager 150-1 may determine that the first parameter satisfies the first threshold criterion.

In another example, a second parameter may be the available capacity of memory allocated to the DU, and a second threshold criterion may define a minimum value of the available capacity of memory allocated to the DU. The assignment manager 150-1 may receive or monitor the second parameter, and compare the second parameter with the second threshold criterion. When the value of the second parameter is smaller than the minimum value defined in the second threshold criterion, the assignment manager 150-1 may determine that the second parameter satisfies the second threshold criterion.

In yet another example, a first parameter may be the number of RUs that can be connected to a specific DU (or each DU in RAN 221-1), a second parameter may be the available capacity of memory allocated to the DU, and a third threshold criterion may define a maximum number of RUs that can be connected a specific DU (or each DU in RAN 221-1), and a minimum value of the available capacity of memory allocated to the DU. The assignment manager 150-1 may receive or monitor the first parameter and the second parameter, and compare the first and second parameters with the third threshold criterion. When the value of the first parameter is larger than the maximum number defined in the third threshold criterion and the value of the second parameter is smaller than the minimum value defined in the third threshold criterion, the assignment manager 150-1 may determine that the first and second parameters satisfy the third threshold criterion.

In some implementations, the assignment manager 150-1 may determine whether one or more parameters of the plurality of parameters satisfy the threshold criterion by predicting a reference value of the parameters based on historical data using a machine learning model and determining whether the reference value satisfies the threshold criterion. For example, when a RU is powered on, the assignment manager 150-1 may predict a reference value of the parameters when the RU is assigned to a specific DU (e.g., the number of RUs, or the available capacity of memory allocated to the DU), and determine whether the reference value satisfies the threshold criterion (e.g., the first threshold criterion, or the second threshold criterion described above).

Responsive to determining that one or more parameters satisfy at least one threshold criterion, the assignment manager 150-1 may adjust the assignment among the RUs, the DUs, and the CUs in RAN 221-1 according to a predefined adjustment policy, for example, such that the threshold criterion is not satisfied anymore. The predefined adjustment policy may be customized.

Using the example illustrated above, when the value of the first parameter is larger than the maximum number defined in the first threshold criterion, the assignment manager 150-1 may determine that the first parameter satisfies the first threshold criterion and adjust the assignment of RUs to the specific DU (or each DU in RAN 221-1) such that the number of RUs is not larger than the maximum number. In some implementations, the predefined adjustment policy may adjust the assignment of the associated RUs, DUs, and CUs such that the threshold criterion is not satisfied anymore but without providing buffering capacity (e.g., reassigning just one RU to other DUs such that the number of RUs connected to the specific DU is below the maximum number). In some implementations, the predefined adjustment policy may adjust the assignment of the associated RUs, DUs, and CUs such that the threshold criterion is not satisfied anymore and the adjusted assignment can take some extra capacity regarding the threshold criterion (e.g., reassigning more than one RUs to other DUs such that the number of RUs connected to the specific DU is much below the maximum number).

Using another example illustrated above, when the value of the second parameter is smaller than the minimum value defined in the second threshold criterion, the assignment manager 150-1 may determine that the second parameter satisfies the second threshold criterion and adjust the assignment of RUs (e.g., reduce the number of RUs assigned) to the specific DU (or each DU in RAN 221-1) such that the available capacity of memory allocated to the DU is not smaller than the minimum value.

In some implementations, the assignment manager 150-1 may receive a request for new assignment of the network elements, for example, at the time that a RU is powered on. The assignment manager 150-1 may start the process of requesting the information of the parameters associated with the new assignment. In some implementations, the assignment manager 150-1 may continuously monitoring the parameters and/or periodically requesting to receive the corresponding information.

In some implementations, upon adjusting the assignment among the RUs, the DUs, and the CUs in RAN 221-1, the assignment manager 150-1 may send the adjustment information to element management system (EMS) 240 such that the corresponding RU(s) can communicate with EMS 240 for the connection with the assigned DU and CU. Although the dynamic assignment is illustrated as being specific to the RUs, the DUs, and the CUs in RAN 221-1, the dynamic assignment of the RUs, the DUs, and the CUs can be performed within any group of the RUs, the DUs, and the CUs.

In some implementations, the assignment manager 150-2 may perform the operations similar to the assignment manager 150-1 described above, except that the region served by the assignment manager 150-2 is different from the RAN 221-1.

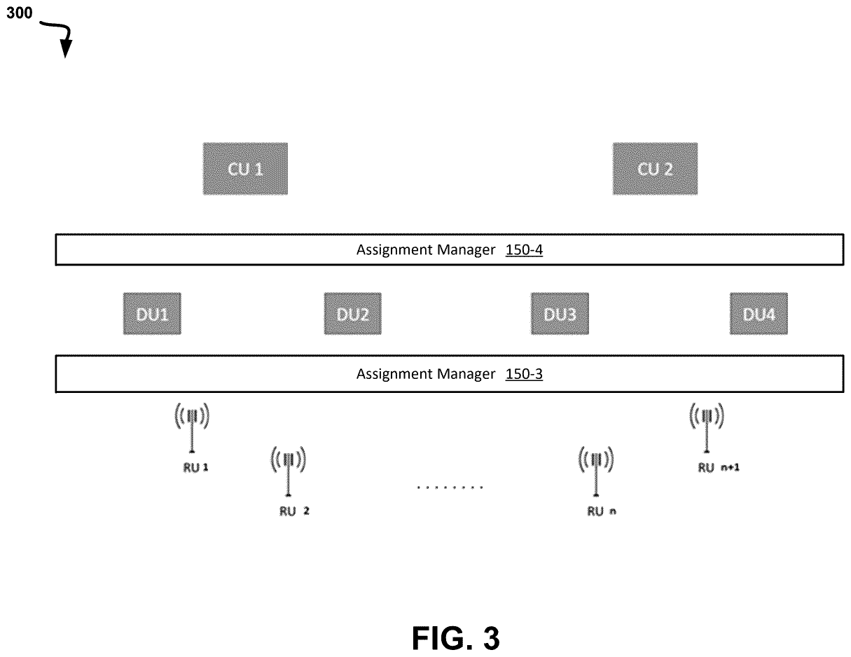

FIG. 3 illustrates example assignment managers that implements dynamic assignment of RUs, DUs, and CUs in a cellular network. In some implementations, the system 300 may include RUs 1-n+1, DUs 1-4, CUs 1-2, the assignment manager 150-3, and the assignment manager 150-4.

In some implementations, the assignment manager 150-3 may monitor the parameters associated with RUs 1-n+1 and the parameters associated with DUs 1-4, and the assignment manager 150-4 may monitor the parameters associated with DUs 1-4 and the parameters associated with CUs 1-2. In some implementations, the assignment manager 150-3 and the assignment manager 150-4 may communicate with each other to exchange the information including the parameters described above.

In one example, the assignment manager 150-3 may monitor the parameters associated with RUs 1-n+1 and DUs 1-4, determine whether at least one of these parameters satisfies one or more threshold criteria, and responsive to determining that at least one of these parameters satisfies one or more threshold criteria, adjust the assignment of RUs 1-n+1 to DUs 1-4.

In another example, the assignment manager 150-4 may monitor the parameters associated with CUs 1-2 and DUs 1-4, determine whether at least one of these parameters satisfies one or more threshold criteria, and responsive to determining that at least one of these parameters satisfies one or more threshold criteria, adjust the assignment of DUs 1-4 to CUs 1-2.

In yet another example, the assignment manager 150-3 and the assignment manager 150-4 may monitor the parameters associated with RUs 1-n+1, CUs 1-2, and DUs 1-4, determine whether at least one of these parameters satisfies one or more threshold criteria, and responsive to determining that at least one of these parameters satisfies one or more threshold criteria, adjust the assignment among RUs 1-n+1, CUs 1-2, and DUs 1-4.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to an assignment manager (e.g., the assignment manager of FIGS. 1-3).

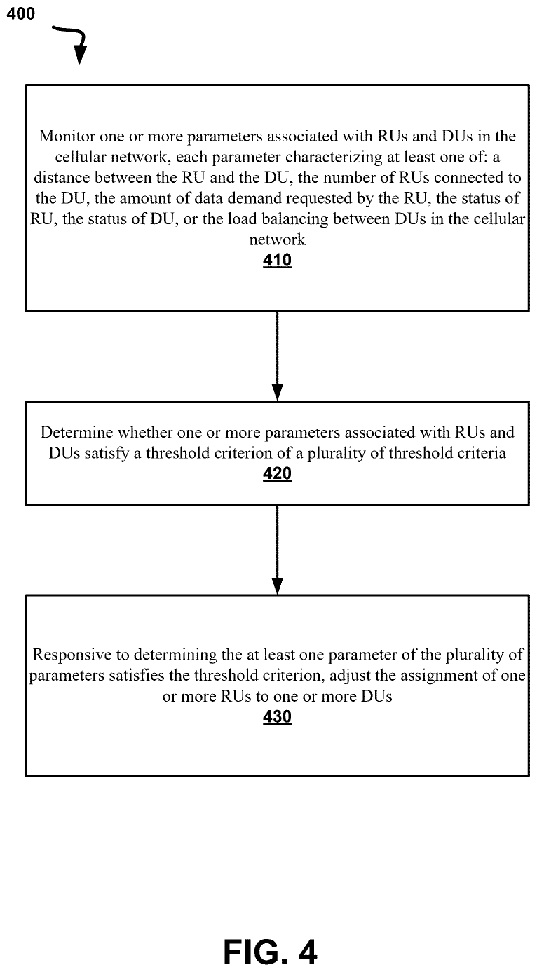

FIGS. 4, 5, and 6 are flow diagrams of methods 400, 500, and 600 of dynamic assignment of RUs, DUs, or CUs in a cellular network according to at least one embodiment. The of methods 400, 500, and 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 400, 500, and 600 are performed by the system 100 of FIG. 1. In one embodiment, the methods 400, 500, and 600 are performed by the assignment manager of FIGS. 1-3. In one embodiment, the method 400 is performed by the assignment manager 150-3, the method 500 is performed by the assignment manager 150-4, and the method 600 is performed by the assignment manager 150-3 and assignment manager 150-4. In one embodiment, the method 400 is specific to the assignment of RUs to DUs, the method 500 is specific to the assignment of DUs to CUs, and the method 600 may be specific to the assignment among RUs, DUs, and CUs.

Referring to FIG. 4, at operation 410, the processing logic may monitor one or more parameters associated with RUs and DUs in the cellular network. In some implementations, each parameter may characterize at least one of: a distance between the RU and the DU, the number of RUs connected to the DU, the amount of data demand requested by the RU, the status of RU, the status of DU, or the load balancing between DUs in the cellular network.

In some implementations, the status of RU comprises at least one parameter specifying one or more of: data transaction handled by RU, an available capacity of RU, an available bandwidth of RU, or power consumption of RU. The available capacity of RU may refer to the available maximum amount of data that a radio transceiver can transmit or receive within a specific time frame.

In some implementations, the status of DU comprises at least one parameter specifying one or more of: data transaction handled by DU, an available capacity of DU, or interference to DU from other network elements. The available capacity of DU may comprise at least one of: the available capacity of memory allocated to the DU, the available capacity of storage allocated to the DU, the available number of CPU allocated to the DU, or the available bandwidth of network interconnection, provided locally (e.g., physically) or in the cloud (e.g., in virtualization), allocated to the DU.

At operation 420, the processing logic may determine whether one or more parameters associated with RUs and DUs satisfy a threshold criterion of a plurality of threshold criteria. In some implementations, the threshold criterion comprises at least one of: a minimum value of the one or more parameters, a maximum value of the one or more parameters, or a range of values of the one or more parameters.

In some implementations, the processing logic may compare at least one parameter associated with RUs and DUs with various threshold criteria for dynamic assignment to determine whether one or more parameters satisfy at least one threshold criterion of a plurality of threshold criteria. In some implementations, the processing logic may predict a reference value of the parameters based on historical data using a machine learning model, and determine whether the reference value satisfies the threshold criterion.

At operation 430, responsive to determining the at least one parameter of the plurality of parameters satisfies the threshold criterion, the processing logic may adjust the assignment of one or more RUs to one or more DUs. In some implementations, adjusting the assignment of one or more RUs to one or more DUs is performed according to a predefined adjustment policy.

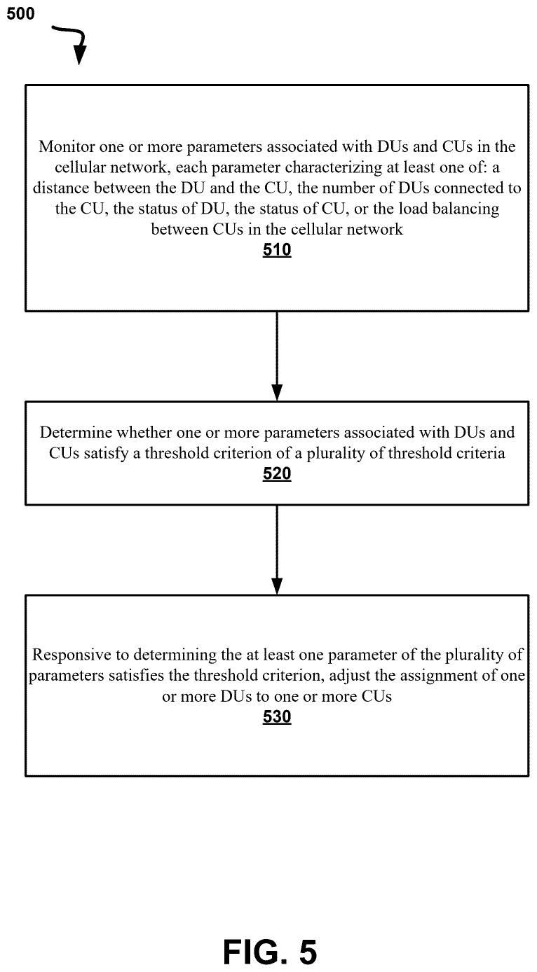

Referring to FIG. 5, at operation 510, the processing logic may monitor one or more parameters associated with DUs and CUs in the cellular network. In some implementations, each parameter may characterize at least one of: a distance between the DU and the CU, the number of DUs connected to the CU, the status of DU, the status of CU, or the load balancing between CUs in the cellular network.

In some implementations, the status of DU comprises at least one parameter specifying one or more of: data transaction handled by DU, an available capacity of DU, or interference to DU from other network elements. The available capacity of DU may comprise at least one of: the available capacity of memory allocated to the DU, the available capacity of storage allocated to the DU, the available number of CPU allocated to the DU, or the available bandwidth of network interconnection, provided locally (e.g., physically) or in the cloud (e.g., in virtualization), allocated to the DU.

In some implementations, the status of CU comprises at least one parameter specifying one or more of: data transaction handled by CU, a capacity of CU, or interference to CU from other network elements. The available capacity of CU may comprise at least one of: the available capacity of memory allocated to the CU, the available capacity of storage allocated to the CU, the available number of CPU allocated to the CU, or the available bandwidth of network interconnection, provided locally (e.g., physically) or in the cloud (e.g., in virtualization), allocated to the CU.

At operation 520, the processing logic may determine whether one or more parameters associated with DUs and CUs satisfy a threshold criterion of a plurality of threshold criteria. In some implementations, the threshold criterion comprises at least one of: a minimum value of the one or more parameters, a maximum value of the one or more parameters, or a range of values of the one or more parameters.

In some implementations, the processing logic may compare at least one parameter associated with DUs and CUs with various threshold criteria for dynamic assignment to determine whether one or more parameters satisfy at least one threshold criterion of a plurality of threshold criteria. In some implementations, the processing logic may predict a reference value of the parameters based on historical data using a machine learning model, and determine whether the reference value satisfies the threshold criterion.

At operation 530, responsive to determining the at least one parameter of the plurality of parameters satisfies the threshold criterion, the processing logic may adjust the assignment of one or more DUs to one or more CUs. In some implementations, adjusting the assignment of one or more DUs to one or more CUs is performed according to a predefined adjustment policy.

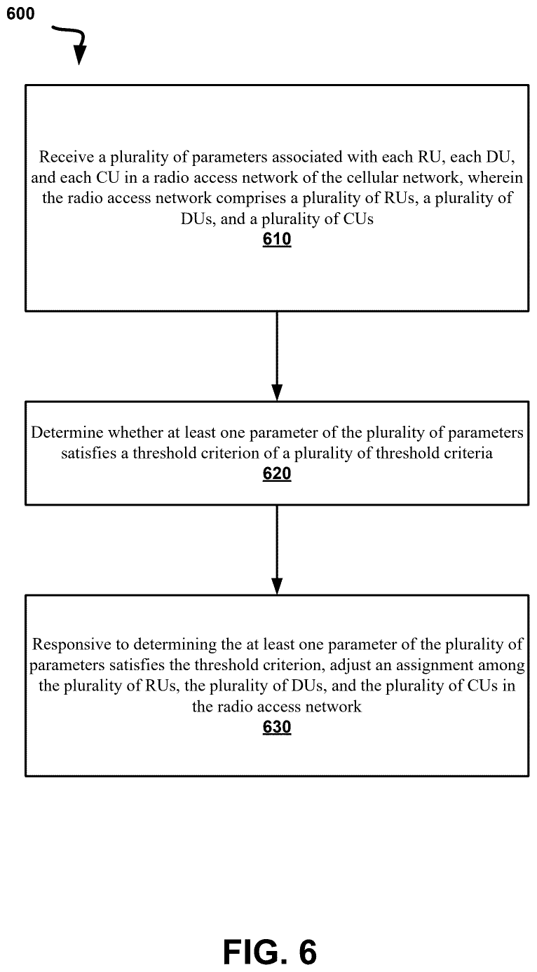

Referring to FIG. 6, at operation 610, the processing logic may receive one or more parameters associated with each RU, each DU, and each CU in a radio access network of the cellular network. In some implementations, the processing logic may receive a plurality of parameters associated with each radio access network (RAN) component of a plurality of RAN components in a RAN of the cellular network, wherein each RAN component of the plurality of RAN components comprises at least one of: Radio Unit (RU), Distributed Unit (DU), or Centralized Unit (CU). In some implementations, the radio access network comprises a plurality of RUs, a plurality of DUs, and a plurality of CUs.

In some implementations, each parameter may characterize at least one of: a distance between the RU and the DU, the number of RUs connected to the DU, the amount of data demand requested by the RU, the status of RU, the status of DU, or the load balancing between the plurality of DUs in the radio access network. In some implementations, each parameter may characterize at least one of: a distance between the DU and the CU, the number of DUs connected to the CU, the status of DU, the status of CU, or the load balancing between the plurality of CUs in the radio access network.

In some implementations, the processing logic may monitor one or more parameters associated with the plurality of RUs and the plurality of DUs in the radio access network. In some implementations, the processing logic may monitor one or more parameters associated with the plurality of DUs and the plurality of CUs in the radio access network.

At operation 620, the processing logic may determine whether at least one parameter of the plurality of parameters satisfy a threshold criterion of a plurality of threshold criteria. In some implementations, the processing logic may determine whether a first parameter of the plurality of parameters satisfies a first threshold criterion of a plurality of threshold criteria, wherein the first parameter is associated with a first RAN component of the plurality of RAN components, and wherein the first RAN component is assigned to connect with a second RAN component of the plurality of RAN components. In some implementations, the first threshold criterion comprises at least one of: a minimum value of the first parameter, a maximum value of the first parameter, or a range of values of the first parameter.

In some implementations, the processing logic may compare at least one parameter associated with RUs, DUs, and CUs with various threshold criteria to determine whether at least one parameter satisfies at least one threshold criterion of a plurality of threshold criteria. In some implementations, the processing logic may predict a reference value of at least one parameter based on historical data using a machine learning model, and determine whether the reference value satisfies the threshold criterion.

At operation 630, responsive to determining at least one parameter satisfies the threshold criterion, the processing logic may adjust the assignment among the plurality of RUs, the plurality of DUs, and the plurality of CUs in the radio access network. In some implementations, responsive to determining that the first parameter of the plurality of parameters satisfies the first threshold criterion, the processing logic may adjust the assignment of the first RAN component to the second RAN component to an assignment of the first RAN component to a third RAN component of the plurality of RAN components. That is, the first RAN component is assigned to connect with the third RAN component after the adjustment. In some implementations, the third RAN component and the second RAN component are the same type of network elements (e.g., both are RUs, both are DUs, or both are CUs). In some implementations, adjusting the assignment among the plurality of RUs, the plurality of DUs, and the plurality of CUs in the radio access network is performed according to a predefined adjustment policy.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of dynamic assignment of radio access network (RAN) components in a cellular network, the method comprising:
receiving a plurality of parameters associated with each RAN component of a plurality of RAN components in a RAN of the cellular network, wherein each RAN component of the plurality of RAN components comprises at least one of: Radio Unit (RU), Distributed Unit (DU), or Centralized Unit (CU);
determining whether a first parameter of the plurality of parameters satisfies a first threshold criterion of a plurality of threshold criteria, wherein the first parameter is associated with a first RAN component of the plurality of RAN components, and wherein the first RAN component is assigned to connect with a second RAN component of the plurality of RAN components; and
responsive to determining that the at least one parameter of the plurality of parameters satisfies the threshold criterion, adjusting the assignment of the first RAN component to the second RAN component to an assignment of the first RAN component to a third RAN component of the plurality of RAN components.

2. The method of claim 1, wherein each parameter of the plurality of parameters characterizes at least one of: a distance between the RU and the DU, a number of RUs connected to the DU, an amount of data demand requested by the RU, a status of the RU, a status of the DU, or a load balancing metric of a plurality of DUs in the radio access network.

3. The method of claim 1, wherein each parameter of the plurality of parameters characterizes at least one of: a distance between the DU and the CU, a number of DUs connected to the CU, a status of the DU, a status of the CU, or a load balancing metric of a plurality of CUs in the radio access network.

4. The method of claim 1, further comprising:
monitoring one or more parameters associated with a plurality of RUs and a plurality of DUs in the radio access network.

5. The method of claim 1, further comprising:
monitoring one or more parameters associated with a plurality of DUs and a plurality of CUs in the radio access network.

6. The method of claim 1, wherein the first threshold criterion comprises at least one of: a minimum value of the first parameter, a maximum value of the first parameter, or a range of values of the first parameter.

7. The method of claim 1, wherein adjusting the assignment is performed according to a predefined adjustment policy.

8. The method of claim 1, wherein determining whether the first parameter of the plurality of parameters satisfy the first threshold criterion comprises:
predicting a reference value of the first parameter based on historical data using a machine learning model; and
determining whether the reference value satisfies the first threshold criterion.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving a plurality of parameters associated with each radio access network (RAN) component of a plurality of RAN components in a RAN of the cellular network, wherein each RAN component of the plurality of RAN components comprises at least one of: Radio Unit (RU), Distributed Unit (DU), or Centralized Unit (CU);
determining whether a first parameter of the plurality of parameters satisfies a first threshold criterion of a plurality of threshold criteria, wherein the first parameter is associated with a first RAN component of the plurality of RAN components, and wherein the first RAN component is assigned to connect with a second RAN component of the plurality of RAN components; and
responsive to determining that the first parameter of the plurality of parameters satisfies the first threshold criterion, adjusting the assignment of the first RAN component to the second RAN component to an assignment of the first RAN component to a third RAN component of the plurality of RAN components.

10. The computing system of claim 9, wherein each parameter of the plurality of parameters characterizes at least one of: a distance between the RU and the DU, a number of RUs connected to the DU, an amount of data demand requested by the RU, a status of the RU, a status of the DU, or a load balancing metric of a plurality of DUs in the radio access network.

11. The computing system of claim 9, wherein each parameter of the plurality of parameters characterizes at least one of: a distance between the DU and the CU, a number of DUs connected to the CU, a status of the DU, a status of the CU, or a load balancing metric of a plurality of CUs in the radio access network.

12. The computing system of claim 9, wherein the operations further comprise:
monitoring one or more parameters associated with a plurality of RUs and a plurality of DUs in the radio access network.

13. The computing system of claim 9, wherein the operations further comprise:
monitoring one or more parameters associated with a plurality of DUs and a plurality of CUs in the radio access network.

14. The computing system of claim 9, wherein the first threshold criterion comprises at least one of: a minimum value of the first parameter, a maximum value of the first parameter, or a range of values of the first parameter.

15. The computing system of claim 9, wherein adjusting the assignment is performed according to a predefined adjustment policy.

16. The computing system of claim 9, wherein determining whether the first parameter of the plurality of parameters satisfy the first threshold criterion comprises:
predicting a reference value of the first parameter based on historical data using a machine learning model; and
determining whether the reference value satisfies the first threshold criterion.

17. One or more non-transitory, computer-readable storage media having computer-readable instructions thereon which, when executed by one or more processing devices, cause the one or more processing devices to perform operations comprising:
receiving a plurality of parameters associated with each radio access network (RAN) component of a plurality of RAN components in a RAN of a cellular network, wherein each RAN component of the plurality of RAN components comprises at least one of: Radio Unit (RU), Distributed Unit (DU), or Centralized Unit (CU);
determining whether a first parameter of the plurality of parameters satisfies a first threshold criterion of a plurality of threshold criteria, wherein the first parameter is associated with a first RAN component of the plurality of RAN components, and wherein the first RAN component is assigned to connect with a second RAN component of the plurality of RAN components; and
responsive to determining that the first parameter of the plurality of parameters satisfies the first threshold criterion, adjusting the assignment of the first RAN component to the second RAN component to an assignment of the first RAN component to a third RAN component of the plurality of RAN components.

18. The one or more non-transitory, computer-readable storage media of claim 17, wherein each parameter of the plurality of parameters characterizes at least one of: a distance between the RU and the DU, a number of RUs connected to the DU, an amount of data demand requested by the RU, a status of the RU, a status of the DU, or a load balancing metric of a plurality of DUs in the radio access network.

19. The one or more non-transitory, computer-readable storage media of claim 17, wherein each parameter of the plurality of parameters characterizes at least one of: a distance between the DU and the CU, a number of DUs connected to the CU, a status of the DU, a status of the CU, or a load balancing metric of a plurality of CUs in the radio access network.

20. The one or more non-transitory, computer-readable storage media of claim 17, wherein adjusting the assignment is performed according to a predefined adjustment policy.
